(19) United States
(12) Patent Application Publication
(10) Pub. No.: US 2005/0000373 A1
(43) Pub. Date: Jan. 6, 2005

(54) Cold Food Server

(75) Inventor: Mark Anthony Coe, Marion, IL (US)

Correspondence Address: MARK A. COE, 4661 RT. 37, MARION, IL, 62959, US

(73) Assignee: Mark Coe Anthony, Marion, IL (US)

(21) Appl. No.: 10/604,019

(22) Filed: Jun. 23, 2003

(51) Int. Cl. A23N 1/00

(52) U.S. Cl. 99/567

(57) ABSTRACT

A food cooler with separate ice and food compartments includes an insulated outer container having an interior partitioning wall, defining a plurality of recessed regions; a peripheral lip extending from the perimeter rim of each recessed region; a plurality of interchangeable inner containers having lids, adapted to form a liquid tight seal with the peripheral lip extending from the perimeter rim of a recessed region of the outer container; a plurality of openings in the base of the outer container having threaded rims; lids adapted to form a liquid tight seal with the threaded rims and; an insulated outer lid adapted to fit with the outer container.

### CROSS REFERENCE TO RELATED APPLICATIONS

There are no other applications related to this application filed in this or any foreign country.

### BACKGROUND OF INVENTION

The subject invention is directed toward the art of ice chests, and more particularly, to a novel cooler that can be used to serve food from within its inner compartments. This novel cooler addresses certain problems inherent with standard present day coolers. Standard coolers are very effective when used to keep beverages cold on outings, picnics etc. Beverages are loaded into the cooler, ice is added and once the beverages are cold, they are removed to be consumed. This particular application allows the ice to come into direct contact with the beverage containers and is very effective. The problem comes when certain foods carried in the cooler are removed from the ice to be served. On a hot day the food can warm quickly. Foods that spoil easily in warm temperatures need to be kept in a cool environment.

A few recent cooler designs have also disclosed a separate food compartment within a cooler chest. The problem with these coolers is that food containers placed in the inner compartment of the cooler are cooled by cold air surrounding them. Air is a poor thermal conductor; therefore, any additional air gaps will diminish thermal conductivity. Even with this type of cooler the food must be removed for serving. Once removed, the food begins to warm.

A novel cooler that keeps food cold while it's being served is needed.

A novel cooler incorporates the use of inner containers that are used to serve food. The food containers remain in the cooler, staying in direct contact with the ice and water; therefore, maintaining sustained and improved thermal conductivity to the food. The only thing separating the food from the ice is a thin layer of plastic or metal. This novel food cooler is designed in such a way that an ice compartment is created when the food containers (made of plastic or thermally conductive metal, i.e.; stainless steel) are attached to the cooler's inner rim(s) or groove. Ice is added through an opening in the base of the outer compartment, which is sealed with a threaded lid. Food can be added to the inner food container(s) and sealed with its own lid. The main cooler lid is attached with four latches located on the sides of the cooler. The novel cooler can be transported to an outdoor event and placed on the table for service. Food can be accessed easily without removing it from the ice. In addition this novel cooler incorporates the use of a plurality of interchangeable inner containers, allowing for multiple container scenarios, increasing its functionality. The novel cooler containers have been specially designed for serving foods like: potato salads, pasta salads, coleslaw, salads, dips, layered guacamole dip, jellos, pudding, cheese cake and condiments such as: mayonnaise, mustard, ketchup, sliced tomatoes, sliced onions, relish, and cheese.

Another advantage of the novel cooler is its low profile. Unlike most coolers that have a deep inner compartment that accommodate a large amount of ice, the novel cooler has a low profile that makes it easier to set on a table top along side of other food containers without towering over them. This application is a particular advantage when it comes to serving foods buffet style at picnics and other events requiring cold food.

### SUMMARY OF INVENTION

The present invention overcomes the noted problems and provides an outer container incorporating an inner partition wall that defines a plurality of recessed regions. The outer container encloses a plurality of interchangeable inner containers used to serve food. The inner containers, being made of plastic or metal, provide improved and sustained thermal conductivity to the food by remaining in contact with the ice while the food is served. The ice compartment is defined between the inner and outer containers. Access to the ice compartment is provided through an opening in the base of the outer container, which is closed by a threaded lid. The novel coolers outer container lid is attached by a plurality of latches located on the sides of the outer compartment. When attached, the outer container lid compresses the rim and lid of the inner container allowing the cooler to be turned over with out spilling food or ice.

A further advantage of the present invention is to provide a plurality of inner compartments increasing its functionality. A single compartment cooler with a single interchangeable inner container would be sufficient for many uses. By dividing the compartment into two or more compartments, the inner container scenarios are tripled i.e.; inner containers;=(a, b, c, d, e, 0, single compartment cooler:=(1CL), two-compartment cooler:=(2CL).

Example 1: (1 CL+a)+(1 CL+b)+(1 CL+c)+(1 CL+d)+(1 CL+e)+(1 CL+e)=6. Six cooler scenarios are gained from a single compartment cooler with six different inner containers.

Example 2: (2CL+a+b)+(2CL+a+c)+(2CL+a+d)+(2CL+a+e)+(2CL+a+f)+(2CL+b+c)+(2CL+b+d)+(2CL+b+e)+(2CL+b+f)+(2CL+c+d)+(2CL+c+e)+(2CL+c+f)+(2CL+d+e)+(2CL+d+f)+(2CL+e+f)+(2CL+a)+(2CL+b)+(2CL+c)+(2CL+d)+(2CL+e)+(2CL+f)=21. Twenty-one different cooler scenarios are gained from a two-compartment cooler with six different inner containers. With a two-compartment cooler the second compartment may be left empty or filled with ice and sealed with a plain lid.

An additional advantage of the present invention is to provide a novel cooler, wherein the base of the outer container defines a plurality of recessed regions, whereby a groove in the rim of the inner compartment is provided allowing for an improved connection, between a metal inner container and the plastic outer container.

It is therefore a primary advantage of the present invention to provide a novel cooler that facilitates the serving of food from an ice filled container with separate interchangeable food compartments.

Additional features are more apparent with the attached drawings and detailed description below.

### BRIEF DESCRIPTION OF DRAWINGS

FIG. 1 is an orthographic cross sectional view along a lengthwise plane of a version of the cold food server, illustrating the open cold food server with an open inner container and ice compartment.

FIG. 2 is a view similar to that of FIG. 1, illustrating the opposite inner container and ice fill lid, in the open position.

FIG. 3 is a view similar to that of FIG. 1 and FIG. 2, illustrating the cold food server in the closed position.

FIG. 4 is an orthographic plan view of the lid, illustrating a recessed region for the handle placement and the four catches located on the sides.

FIG. 5 is an orthographic plan view of the of the base of the outer container, illustrating a recessed region and ice fill opening; an inner container in place and the four latches that attach to the outer lid.

FIG. 6 is an orthographic plan view of the bottom of the outer container, illustrating an ice fill opening and a lid in place.

FIG. 7 is an orthographic cross sectional view, taken from an end-view, 90 degrees to that of FIG. 1, illustrating the handle and latch movements.

FIG. 8 is an expanded orthographic cross sectional view of the cold food server's inner container connections.

FIG. 9 is an expanded orthographic cross sectional view of the cold food server's optional inner container connections.

FIG. 10 is an orthographic cross sectional view along a lengthwise plane of a second version of the cold food server, illustrating the cold food server with a single inner container and ice compartment.

FIG. 11 is an orthographic cross sectional view, taken from an end-view, 90 degrees to that of FIG. 10, illustrating the handle and latch movements; inner container and ice lid orientation.

FIG. 12 is a plan view and orthographic cross sectional view of an inner container and associated lid.

FIG. 13 is a plan view and orthographic cross sectional view of an inner container and associated lid.

FIG. 14 is a plan view and orthographic cross sectional view of an inner container and associated lid.

FIG. 15 is a plan view and orthographic cross sectional view of an inner container and associated lid.

FIG. 16 is a plan view and orthographic cross sectional view of an inner container and associated lid.

FIG. 17 is a plan view and orthographic cross sectional view of an inner compartment lid.

### DETAILED DESCRIPTION

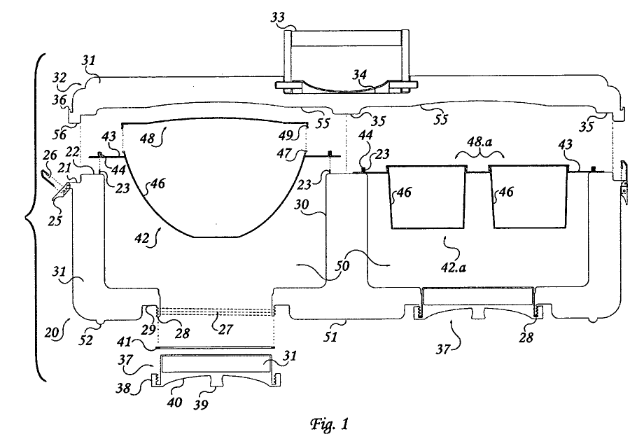

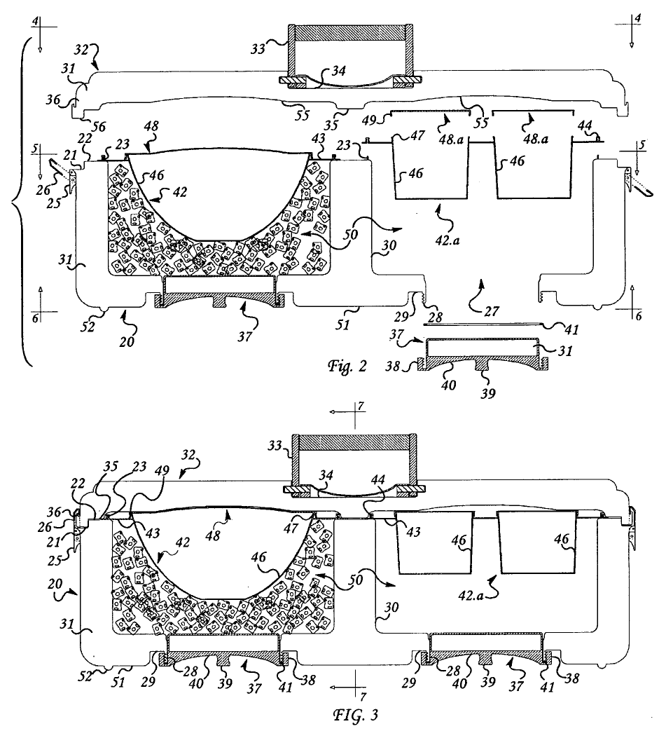

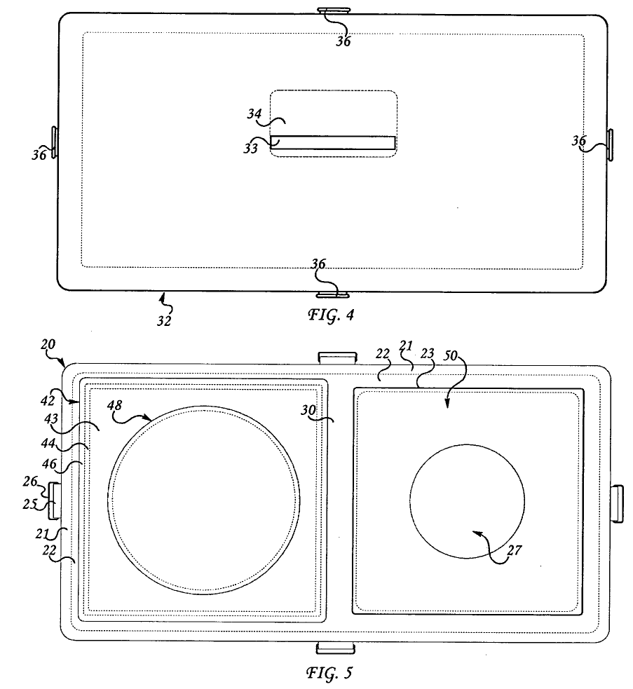

Referring now to the drawings wherein the showings are for the purposes of illustrating the preferred embodiment of the invention only, and not for purposes of limiting same, FIG. 1-7 in general, a novel cooler constructed in accordance with the principles of the invention includes; an outer container 20, having an outer lid 32 and a plurality of interchangeable inner containers 42-42.d with lids 48-48.e contained within the outer container 20; a plurality of circular openings 27 in the base, associated O-rings 41 and lids 37.

Referring to FIG. 1-6, it can be seen that an outer container 20 includes a body, having a base 51 with foot 52, sidewalls and an interior partition wall 30 defining a plurality of recessed regions 50; a perimeter rim 22 of an upper portion of the outer sidewalls defining notch 21; and a perimeter rim of an upper portion of the inner sidewalls defining a peripheral lip 23; a plurality of circular openings 27 in the base 51 are defined by peripheral rims 28 extending outward from an inner portion of the inner surface of the base; notches formed in the outer surface base extend outwardly from the rims 28 defining annular grooves 29.

As seen in FIG. 1-3 the base 51 having a foot 52 supports the sidewalls and interior partition wall 30, formed of inner and outer surfaces between which is carried an insulating layer 31. The base and sidewall material may be formed of rigid plastic, with an insulating layer formed of a low thermally conductive material such as rigid foam. An upper perimeter rim 22 of the outer sidewalls defines a notch 21 sized to form a snug fit with the notch 35 and tongue 56 of the outer lid. An upper perimeter rim 22 of the inner sidewalls defines a peripheral lip 23 extending upwardly from a region of the rim. The peripheral lip is size to form a liquid tight seal with a peripheral rim 44 defined on an outer region of a flange 43 extending from the peripheral wall of an inner container 42-42.d.

As seen in FIGS. 1-4 the outer container 20 is fitted with an outer lid 32, attached by a plurality of latches 25, 26 carried by the outer container. The outer container lid 32 formed of an inner and outer surface between which is carried an insulating layer 31 includes: a peripheral rim extending downward from a perimeter of the lid, defining a tongue 56 and notch 35 sized to form a snug fit with the rim 22 and notch 21 of the outer container 20. A plurality of recessed regions 55 are defined on the under surface of the lid, sized incrementally larger than the space needed for the inner container peripheral rim 44 and lid 48-48.e. A recessed region 34 is defined on the upper surface of the lid wherein a handle 33 is mounted. A plurality of catches 36 is defined on a lower region of the perimeter edge of the lid. The catches are sized incrementally smaller to receive a latching mechanism 26 mounted on the outer container.

As seen in FIGS. 1-3 and FIG. 6, the ice fill openings 27 are defined by threaded peripheral rims 28 extending from a region of the inner surface of the base 51. The openings are sealed with lids 37 that incorporate an O-ring 41. The lids 37 formed of inner and outer surfaces between which is carried an insulating layer have finger grips 38 formed along the perimeter; and a handle 39 defined between two concave depressions 40 formed in the outer surface of the lid. The finger grip 38 and handle 39 aids in the ability to remove and tighten the lid.

As seen in FIGS. 1-3, a plurality of interchangeable inner containers 42-42.d is carried within an outer container, having a plurality of recessed regions 50 defined within. The inner containers, formed of plastic or metal include a bottom and a peripheral wall; a flange 43 extending outwardly from an upper portion of the peripheral wall, having a peripheral rim 44 defined on an outer region of the flange 43, sized to form a liquid tight seal with the peripheral lip 23 of an interior compartment of the outer container 20; and an upper end of the inner container body having a peripheral rim 47. The inner containers are sealed with lids 48-48.e formed of plastic, having a peripheral edge 49 sized to form a liquid tight seal with the peripheral rim 47.

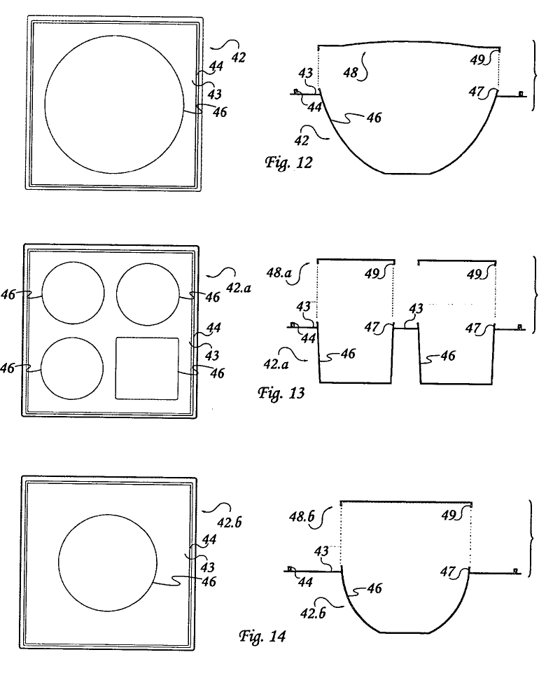

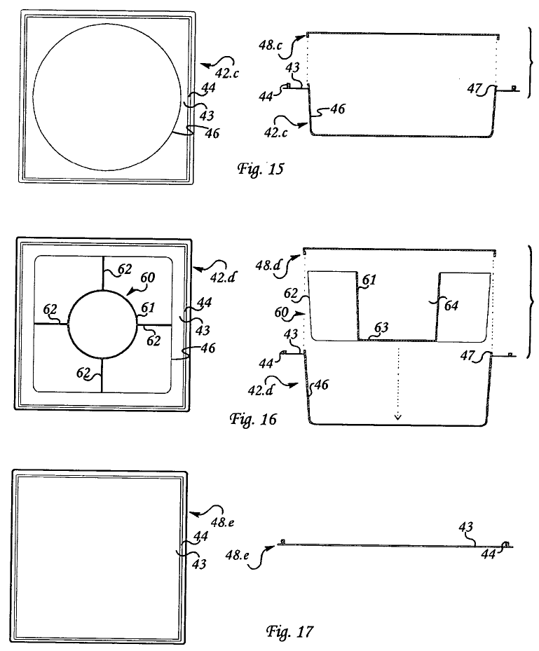

In FIGS. 12-17 a variety of inner containers is provided to meet a wide range of needs. Inner container 42 a circular shaped bowl with lid 48 designed to serve foods such as potato salad, pasta salads etc. Inner container 42.a incorporates a plurality of frustum shaped regions, and a cubical region with associated lids 48.a; designed to serve foods and condiments such as; relishes, dips, sliced cheese etc. Inner container 42.b a circular shaped bowl with lid 48.b designed to serve foods such as; potato salad, pasta salads, pudding etc.; anything that inner container 42 would serve, only in a smaller amount. Inner container 42.c a wide frustum shaped region with lid 48.c designed to serve foods such as cheesecakes etc. Inner container 42.d a cubical shaped region with lid 48.d designed to serve foods such as; layered salads, layered guacamole dip etc.; with insert 60 the inner container converts to a vegetable tray for dips and vegetables. A flat lid 48.e with a peripheral rim 44 defined on a region of a perimeter of the lid, sized to form a liquid tight seal with the peripheral lip 23 of the outer container 20 designed for storing ice or cold canned beverages within the recessed region 50 defined below the lid 48.e.

As seen in FIG. 16 an insert 60 formed of plastic, having a base 63 and sidewall 61; a plurality of vertical flanges 62 extending outwardly from a region of the outer sidewall 61 sized incrementally smaller to fit within inner container 48.d.

In use a plurality of inner containers 42-42.d are selected and attached to the outer container peripheral lip 23 forming an ice compartment 50 beneath. Ice is then added to the cooler through openings 27 in the base 51. An O-ring 41 and lid 37 seal the openings 27. Food is then placed within the selected inner containers and sealed with the corresponding inner container lids 48-48e. The outer lid 32 is attached to the outer container 20 by a plurality of latches 25, 26. The cooler can be lifted by the handle 33 and placed in service. When in service, the latches 25, 26 are unhooked and the inner container lids 48-48e are removed. The outer lid 32 should be placed back on the outer container 20 to help keep the food cool, or it may be placed under the outer container 20 along with any inner container lids. The handle 33 should be folded down and the inner container lids may be placed in a recessed region 55 defined by the peripheral notch 35 and tongue 56. A lid 48.e is provided for leaving an inner region 50 empty, or for storing additional ice, or cold soft drinks. An insert 62 may be added to inner container 42.d for converting the region to a vegetable tray, or used serve drink garnishments.

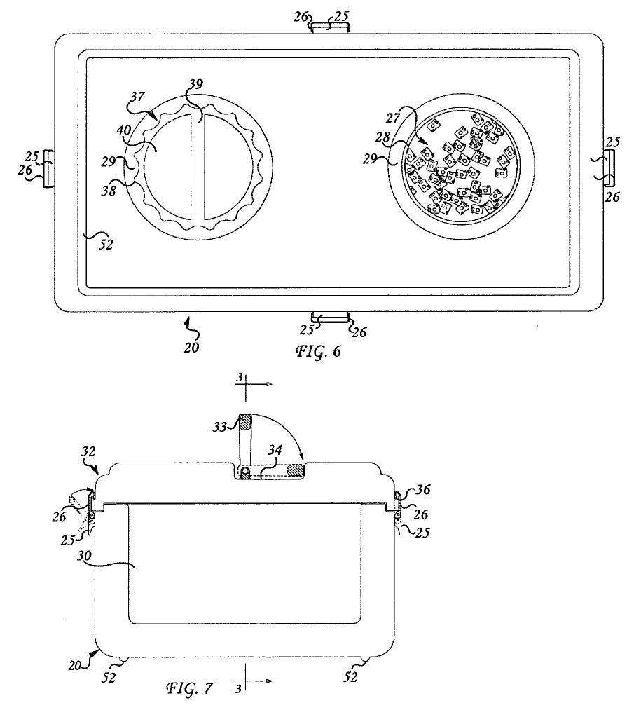

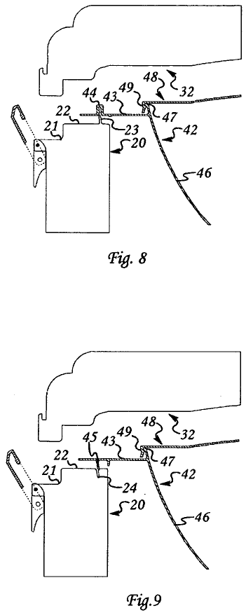

As seen in FIG. 7-8, an additional connection arrangement is offered, wherein a peripheral groove 24 and lip 45 is offered as apposed to the lip 23 and rim 44 of FIG. 7.

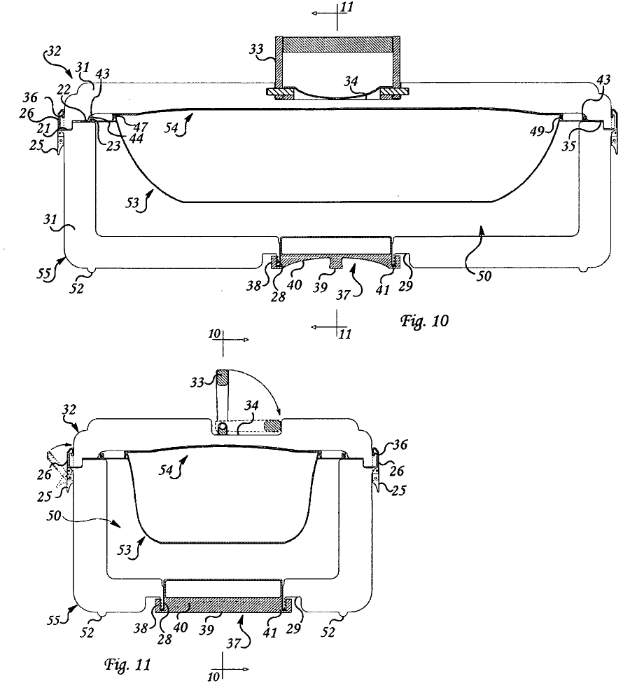

As seen in FIGS. 10-11, an additional cooler configuration is offered, wherein a single inner container 53 and lid 54 is carried within an outer container 55. This cooler design is identical to the aforementioned cooler with in every respect with a few exceptions. The inner container 53, inner compartment 50 and ice fill opening 27 are no longer plural.

The invention has been described with reference to the preferred embodiment. Obviously, modifications and alterations will occur to others upon a reading and understanding of this specification. It is intended to include all such modifications and alterations insofar as they come within the scope of the appended claims or the equivalents thereof.

In compliance with US Patent laws, the invention has been described in a language more or less specific as to methodical features. The invention, is not however, limited to the specific features described, since the means herein disclosed comprise preferred forms of putting the invention into effect. The invention is therefore claimed in any of its forms or modifications within the scope of the appended claims appropriately interpreted in accordance with the doctrine of equivalents.

1. A cold food server comprising:
(A) an outer container comprising:
(a) a base, formed of inner and outer surfaces between which is carried an insulating layer defining a plurality of recessed regions;
(b) sidewalls extending from a perimeter of the base, formed of vertical inner and outer surfaces between which is carried an insulating layer;
(c) a perimeter rim of an upper portion of the sidewalls defining a notch;
(d) an inner partition wall extending from the base, formed of vertical inner and outer surfaces between which is carried an insulating layer, defining a plurality of recessed regions;
(e) a peripheral lip, extending upward from the perimeter rim of an interior region sidewalls;
(f) a plurality of circular openings in the base, formed of an insulating layer;
(g) a threaded rim, extending outwardly from a perimeter of each of the circular openings;
(h) a notch in the base, extending outwardly from the threaded rim of each circular opening, defining an annular groove around the rim;
(i) a latch affixed to the upper portion of each of the four exterior sidewalls;
(B) an outer lid carried by the outer container comprising:
(a) a flat top formed of inner and outer surfaces between which is carried an insulating material;
(b) a rectangular recessed region formed on a region of the upper surface of the flat top;
(c) a handle, supported by a cylindrical pin, affixed within a portion of the recessed region;
(d) a peripheral edge of a perimeter of the flat top;
(e) a perimeter rim and notch, defined on a lower portion of the peripheral edge of the flat top, sized to seal with the perimeter rim and notch of the outer container;
(f) a plurality of recessed regions defined on the lower surface of the flat top, sized to create a space for the inner container rims and lids;
(g) a plurality of catches formed on the peripheral edge of the flat top, sized to receive a latching mechanism;
(C) a plurality of interchangeable inner containers, carried within the outer container, comprising:
(a) a bottom, and a peripheral wall, formed of plastic or metal;
(b) a flange, extending outwardly from an upper portion of the peripheral wall, having a peripheral rim defined on an outer region of the flange, sized to form a (c) liquid tight seal with the peripheral lip of an interior compartment, of the outer container;
(d) an upper end of the inner container body, having a peripheral rim;
(e) a lid, formed of plastic, having a peripheral edge sized to form a liquid tight seal with the peripheral rim;
(D) a plurality of circular shaped lids carried by the outer container comprising:
(a) a flat lid formed of inner and outer surfaces between which is carried an insulating layer;
(b) a peripheral rim defining a plurality of concave shaped finger grips;
(c) a threaded region defined on an inner portion of the peripheral rim, sized to form a liquid tight seal with a threaded lip on the base of the outer container;
(d) a bisected, concave region defining a handle;
(e) an “0” ring formed of a flexible material.

1. The cold food server of claim 1 wherein said upper portion of the interior compartment sidewalls having a peripheral groove, and wherein said plurality of interchangeable inner containers having a flange, extending outwardly from an upper portion of the peripheral wall, having a peripheral rim defined on an outer region of the flange sized to form a liquid tight seal with the groove in the peripheral rim of an interior compartment

1. The cold food server of claim 1 wherein said outer container having a single inner compartment, and wherein said outer container having a single inner container comprising:
(a) a bottom, and a peripheral wall, formed of plastic or metal;
(b) a flange, extending outwardly from an upper portion of the peripheral wall, having a peripheral rim defined on an outer region of the flange, sized to form a liquid tight seal with the peripheral lip of an interior compartment, of the outer container;
(c) an upper end of the inner container body, having a peripheral rim;
(d) a lid, formed of plastic, having a peripheral edge sized to form a liquid tight seal with the peripheral rim;

1. The cold food server of claim 3 wherein said upper portion of the interior compartment sidewalls, having a peripheral groove, and wherein said inner container, having a flange extending outwardly from an upper portion of the peripheral wall, having a peripheral lip defined on an outer region of the flange, sized to form a liquid tight seal with a groove in the peripheral rim of an interior compartment.
